(19) United States
(12) Patent Application Publication
(10) Pub. No.: US 2013/0115947 A1
(43) Pub. Date: May 9, 2013

(54) METHOD FOR INTEGRATING USER EQUIPMENT FUNCTIONS TO FEMTOCELL

(71) Applicant: Pei-Ren Xie, JiangSu (CN)

(72) Inventor: Pei-Ren Xie, JiangSu (CN)

(73) Assignee: SERNET (SUZHOU) TECHNOLOGIES CORPORATION, JIANGSU (CN)

(21) Appl. No.: 13/616,581

(22) Filed: Sep. 14, 2012

(30) Foreign Application Priority Data
Nov. 7, 2011 (CN) 201110347857.7

(51) Int. Cl. H04W 60/00; H04W 4/14

(52) U.S. Cl. 455/435.1

(57) ABSTRACT

A method for integrating UE functions to a femtocell is provided. The method comprises the following steps. The femtocell with a subscriber identity module (SIM) is activated. The femtocell reads the information of the SIM. Based on the information of the SIM, the femtocell registers to a core network via an Internet. The femtocell having successfully registered to the core network provides SMS service, MMS service or Call service.

This application claims the benefit of People's Republic of China application Serial No. 201110347857.7, filed Nov. 7, 2011, the subject matter of which is incorporated herein by reference.

### BACKGROUND OF THE INVENTION

1. Field of the Invention

The invention relates in general to a method for integrating user equipment (UE) functions to a femtocell.

2. Description of the Related Art

In the telecommunication industry, the femtocell is a cellular base station normally used in a household or a small business entity. The femtocell, connected to the telecom operator's core network via a broadband (such as digital subscriber line (DSL), cable or optical fiber), may integrate 2G, 3G and WiFi in one machine. However, the femtocell cannot provide services if there is no user equipment (UE) within the service coverage.

### SUMMARY OF THE INVENTION

The invention is directed to a method for integrating UE functions to a femtocell, such that the femtocell is able to provide services of UE functions.

According to an embodiment of the present invention, a method for integrating UE functions to a femtocell. The method comprises the following steps. The femtocell with a subscriber identity module (SIM) is activated. The femtocell reads information of the SIM. Based on the information of the SIM, the femtocell registers to a core network via an Internet. After the femtocell has successfully registered to the core network, the femtocell provides SMS (Short Message Service) service, MMS (Multimedia Messaging Service) service or Call service.

The above and other contents of the invention will become better understood with regard to the following detailed description of the preferred but non-limiting embodiment(s). The following description is made with reference to the accompanying drawings.

### BRIEF DESCRIPTION OF THE DRAWINGS

FIG. 1 shows a flowchart of a method for integrating UE functions to a femtocell according to an embodiment.

### DETAILED DESCRIPTION OF THE INVENTION

According to the method for integrating UE functions to a femtocell disclosed in the disclosure, the femtocell integrated with UE functions is able to provide function service even when there is no UE within the service coverage.

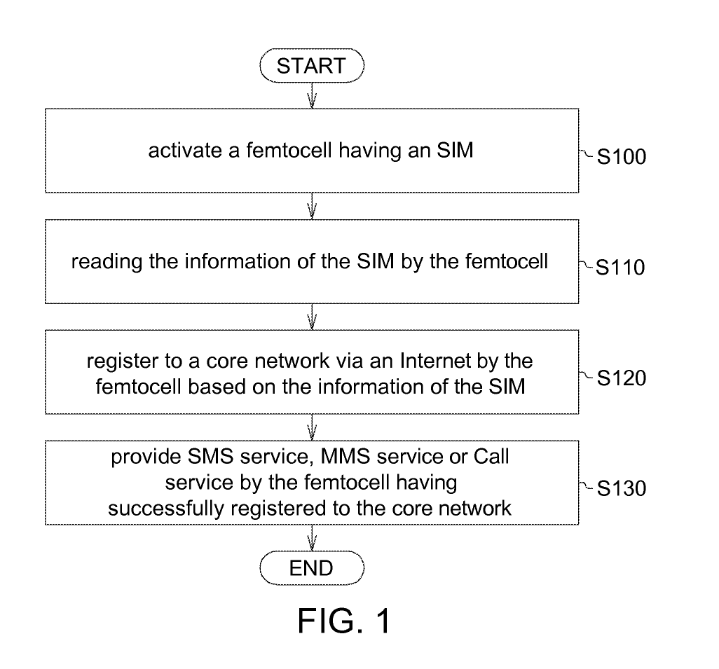

Referring to FIG. 1, a flowchart of a method for integrating UE functions to a femtocell according to an embodiment is provided. In step S100, a femtocell with a subscriber identity module (SIM) is activated. Next, the method proceeds to step S110, the femtocell reads the information of the SIM. The information of the SIM is mainly used for the telecom operator, which provides service, to verify whether the femtocell is an authorized user.

In step S120, based on the information of the SIM, the femtocell registers to a core network of the telecom operator via an Internet. If registration is not successful, the telecom operator regards the femtocell as an unauthorized user and declines to provide service. If registration in step S120 is successful, then the method proceeds to step S130, the telecom operator regards the femtocell as an authorized user. Like an ordinary mobile phone, the femtocell may provide UE functions such as SMS service, MMS service or Call service. Meanwhile, after integrating UE functions to the femtocell, the femtocell may work in conjunction with smart appliances or security protection.

For example, after the femtocell registers to a core network based on the information of the SIM, the femtocell has a telephone number. The user when going outside may dial the telephone number to connect to the femtocell. For example, the user may remotely control the lamps the air-conditioner in a household by pressing the press-key “1” or “2”. Besides, when a mobile phone with a specific telephone number (such as the children's mobile phone) enters the service coverage of the femtocell, a short message is automatically sent to inform the parents who are outside that the children have arrived home safely.

Besides, after UE functions are integrated to a femtocell, the femtocell is still capable of providing conventional femtocell services, such as connecting a mobile terminal to a core network via an Internet.

The disclosure proposes the method for integrating UE functions to a femtocell in above embodiments, and UE functions are integrated to the femtocell without using complicated protocols. After the femtocell successfully registers to a telecom operator, the femtocell may provide services of UE functions even when no UE is within the service coverage and may work in conjunction with smart appliances and security protection, so as to provide more convenience to the user.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for integrating UE (user equipment) functions to a femtocell, comprising:
activating the femtocell having a subscriber identity module (SIM);
reading information of the SIM by the femtocell;
registering to a core network via an Internet by the femtocell based on the information of the SIM; and
providing SMS (Short Message Service) service, MMS (Multimedia Messaging Service) service or Call service from the femtocell after the femtocell having successfully registered to the core network.

2. The method for integrating UE functions to a femtocell according to claim 1, further comprising:
connecting a mobile terminal to the core network via the Internet by the femtocell.
